(19) United States
(12) Patent Application Publication
(10) Pub. No.: US 2018/0300826 A1
(43) Pub. Date: Oct. 18, 2018

(54) AUTOMATIC ALERT AND LEAD GENERATION SYSTEM

(71) Applicant: Allan N. Weiss, Medfield, MA (US)

(72) Inventor: Allan N. Weiss, Medfield, MA (US)

(21) Appl. No.: 15/956,723

(22) Filed: Apr. 18, 2018

Related U.S. Application Data
(60) Provisional application No. 62/486,902, filed on Apr. 18, 2017.

(51) Int. Cl. G06Q 50/16; G06F 17/30; G06Q 40/02

(52) U.S. Cl. CPC G06Q 50/16; G06Q 40/025; G06F 17/30864

(57) ABSTRACT

Provided is a technology platform configured to provide alerts to real estate consumers and professionals. The foregoing can include an application program (or “app”) executable on a mobile phone, or other electronic device, to process data and generate and output alerts to a user of the device. The alerts can be sent to the app when one or more properties satisfy a user's criteria for a target property. The technology platform can process user property search criteria related to dynamically changing values of a property or related to qualitative aspects of a property. The app, with the support of a platform, can provide a real-time, location-based real estate property tour through a mobile device. In some forms, the technology platform can pair lead generation capabilities for real estate agents/brokers and/or mortgage brokers/lenders with real estate search functionality and information.

### CROSS REFERENCE TO RELATED APPLICATIONS

This application claims the benefit of priority under 35 U.S.C. § 119(e) from co-pending, commonly owned Provisional Patent Application 62/486,902, entitled Automatic Alert and Lead Generation System, filed on Apr. 18, 2017 in the United States Patent & Trademark Office (USPTO), the disclosure of which is incorporated herein by reference in its entirety.

### FIELD OF INTEREST

The present inventive concepts relate to the field of computer-based systems useful in the field of real estate listing and transactions related to sales of real estate.

### BACKGROUND

Existing real estate search and listing systems allow users to search for properties based on zip codes or town names. Search results can be filtered by the static quantitative categories of information that form part of a typical multi-listing service (MLS) property listing. Such static quantitative categories of information include property type (e.g., single family, condo, etc.), number of bedrooms, number of bathrooms, square feet of living space, lot size, and so forth. These categories of information are considered to be static because they are presumed not to change over time. These categories are also considered to be quantitative because they relate to measured quantities of something, rather than its quality.

To date, a technology platform does not exist that processes user property search criteria related to dynamically changing values of a property or related to qualitative aspects of a property.

Additionally, a technology platform does not exist that provides a user with real-time, location-based real estate property information in the form of a tour facilitated through a mobile device.

Additionally, a technology platform does not exist that pairs lead generation capabilities for real estate agents/brokers and/or mortgage brokers/lenders with real estate search functionality and information.

### SUMMARY

Provided is a technology platform configured to provide real estate property search and alerts to real estate consumers and professionals. The technology platform can include a computer program product, processors, and data storage devices cooperating to perform various real estate property search and alert functions. The foregoing can include an application program (or “app”) executable on a mobile phone, or other electronic device, to process data and generate and output alerts to a user of the device. The alerts can be sent to the app when one or more properties satisfy a user's criteria for a target property.

In various embodiments, the platform is configured to provide alerts when a house with an “attractive” price is indicated. An attractive price can be determined when a property comes on the market at an asking price below a forecasted or independently determined market value or price or when a house already listed has a price reduction such that the new asking price is below a forecasted or independently determined market value or price.

In various embodiments, the alerts can be generated by the platform and communicated through the app, or though other electronic means (e.g., text message, email, etc.

In various embodiments, such alerts can be generated to the homeowner (“seller”) and the home buyer (also, “client buyer” or “buyer”), rather than or in addition to the real estate agent, so that the seller and the buyer can move swiftly to place and accept an offer on the house.

In some embodiments, a first user, such as a real estate agent, can electronically provide the app to a customer in a manner that enables the app to use the real estate agent's MLS Number, which in turn enables the app to have the authorization to access the agents local MLS database so the prospective buyer can see houses that are for sale as the app searches for them.

In some embodiments, the real estate agent provide the app for free to the prospective buyer.

In some embodiments, when the prospective buyer finds the house using the app, the real estate agent's sales commission will be revealed via the app to the buyer.

In various embodiments, the platform and/or app is configured to provide a client buyer with a lead for mortgage broker or lender. In some embodiments, the platform and/or app provides only one mortgage broker or lender lead. Leads can be displayed as alerts in the app, e.g., in the form of a selectable icon or button.

In some embodiments, in order for the app to provide a prospective buyer with search and/or tour functions, the perspective buyer must be preapproved for a mortgage by that mortgage broker or lender. Such preapproval can be accomplished through or otherwise registered with the app and/or platform.

The mortgage broker or lender, therefore, will regard the app as a lead generation device. In some embodiments, a mortgage broker or lender will pay a lead generation fee each time a real estate agent provides the app to a prospective buyer with the mortgage bank listed as the only bank on the app.

In accordance with another aspect of the inventive concept, provided is a real estate alert generation platform, comprising: at least one processor and data storage device accessible via a computer network; a set of functional modules comprising computer program code stored in the data storage device and executable by the at least one processor; a computer application (app) loadable on a user device and configured to perform a set of functions in conjunction with the set of functional modules. The set of functions includes receiving buyer search criteria, including criteria relating to at least one of dynamic property value criteria and qualitative criteria; processing the buyer search criteria to find one or more target real estate properties satisfying the buyer search criteria; and generating alerts for output via the app identifying the one or more target real estate properties.

The dynamic property value criteria relate to or represent dynamically changing values of a property over time. The dynamic property value criteria or related to qualitative aspects of a property, as opposed to merely quantitative (or static) criteria. Qualitative criteria include criteria relating to quality of life, which can be personal to a buyer.

In some embodiments, the app is loaded on a mobile device.

In some embodiments, the set of functions includes generating a tour including providing alerts via the app in conjunction with a location of user device.

In some embodiments, set of functions includes providing a mortgage lead module configured to provide a link to a mortgage broker or lender via the app on the user device.

In some embodiments, the set of functions includes providing a real estate agent or broker lead module configured to provide a link to a real estate agent or broker via the app on the user device.

In accordance with another aspect of the inventive concept, provided is a real estate alert generation method, as shown and described.

In accordance with another aspect of the inventive concept, provided is a real estate alert generation method, as shown and described.

In accordance with another aspect of the inventive concept, provided is a real estate alert generation system, as shown and described.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a block diagram of an embodiment of a real estate alert and lead generation system, in accordance with aspects of the inventive concept;

FIG. 2 is a diagram of an embodiment of a mobile phone having a real estate alert and lead generation application (app), in accordance with aspects of the inventive concept;

FIG. 3 is a flowchart of an embodiment of the real estate alert and lead generation method, in accordance with aspects of the inventive concept;

FIG. 4 is a diagram of an embodiment of a mobile phone having a real estate alert and lead generation application criteria input display, in accordance with aspects of the inventive concept;

FIG. 5 is a diagram of an embodiment of a mobile phone having a real estate alert and lead generation application (app) display providing a real estate agent lead, in accordance with aspects of the inventive concept;

FIG. 6 is a diagram of an embodiment of a mobile phone having a real estate alert and lead generation application (app) display for a touring mode, in accordance with aspects of the inventive concept; and

FIG. 7 is a diagram of an embodiment of a mobile phone having a real estate alert and lead generation application (app) providing a mortgage lead, in accordance with aspects of the inventive concept.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspects of the inventive concept, a real estate alert and lead generation system and method enable new criteria to be used to dictate the process of finding and purchasing a home. Financial considerations and quality of life are most important to many buyers. The system and method enable buyers to do their own research to find the right home based on what is important to them, beyond the more traditional static criteria used in real estate searching.

A user device can have an application program (or “app”) installed thereon that provides communication and data exchange with a real estate alert and lead generation system. The user device can be a mobile device, e.g., a smartphone, tablet, phablet, or the like, a laptop, or other computer, which are collectively referred to herein as “user device.”

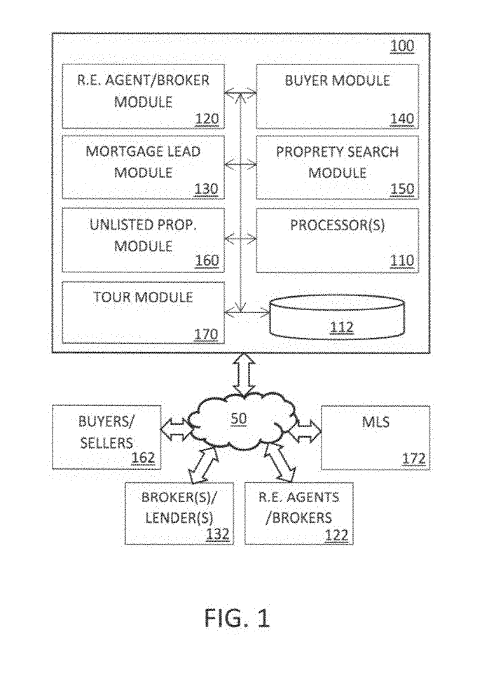

FIG. 1 is a block diagram of an embodiment of a technology platform 100 that provides real estate alert and lead generation functionality within a system of networked computers of various types. Platform 100 includes several functional modules that can be implemented in computer program code stored in memory 112 and executable by one or more processors 110. Platform 100 can comprise one or more network accessible servers providing data storage and processing capabilities. As will be discussed in detail below, platform 100 performs certain data storage and processing not performed by prior real estate search and listing systems.

Platform 100 is configured to communicate with a variety of types of user systems and information sources via one or more network 50, e.g., the Internet, GPS, cellular networks, and so on, to accomplish a real estate alert and lead generation method.

A real estate (R.E.) agent/broker module 120 is executable to establish and manage R.E. agent/broker accounts (or registrations) within platform 100. For each R.E. agent/broker account, a plurality of data can be stored in memory 112, such as agent/broker identification and contact information, property listings, and client information. The clients can be current and/or prospective sellers and/or buyers. Through its registration, an agent/broker has the ability to electronically forward the app (see App 200), or a link to it, to an existing or potential client. If the real estate agent/broker has relationships with other services providers, the real estate agent/broker can optionally include a link to such other service providers as a lead generation tool. A mortgage broker or lender can be one such service provider. Other service providers could include builders, contractors, landscapers, and other tradesmen.

The R.E. agent/broker module 120 can be configured to communicate with the buyers/seller systems 162, MLS systems 172, R.E. agents/brokers systems 122, and/or other service provider systems, e.g., mortgage brokers/lenders systems 132, via network 50. For example, a real estate agent operating from her cell phone or computer can access module 120 of technology platform 100 to communicate with a buyer via App 200 (discussed below) loaded on the buyer's cell phone or computer.

In some embodiments, a real estate agent can send App 200 to a buyer or seller or send a link to platform 100 via an email, text, or other electronic communication with an invitation for the buyer or seller to download and install App 200. Otherwise, the buyer or seller could access platform 100 himself and download App 200 and, from App 200, choose or associate with a real estate agent or broker.

Once App 200 is installed by the user, lead generation mechanisms dictated by the R.E. agent/broker can be included in screens or other outputs of App 200 presented on the user's device. For example, a link to a mortgage broker or lender, or other service provider, can be included in the screens presented by App 200, where the link to the mortgage broker or lender was initiated by the R.E. agent.

A buyer operating though App 200 can access MLS system 172 to access listings of a particular MLS registered agent/broker and, optionally, other listings. App 200 and/or platform 100 can utilize an MLS registration information of the agent/broker, e.g., via an MLS identification number, when accessing the MLS system 172. In a sense, an agent/broker can “loan” or “leverage” its MLS registration to a buyer using App 200. In preferred embodiments, the agent's/broker's MLS number is not presented directly to or exposed to the buyer, so the agent's/broker's MLS number is maintained confidential by App 200 and/or platform 100. In some embodiments, App 200 and/or platform 100 can embed the MLS number of the agent/broker in communications from App 200 accessing the MLS system 172, to maintain the MLS identification number as private and unexposed to the buyer or others.

A Mortgage lead module 130 can be configured to enable platform 100 to generate mortgage leads to buyers of lenders and/or mortgage brokers, preferably lenders and/or mortgage brokers registered with platform. Mortgage lead module 130 can be configured to communicate with mortgage lender(s)/broker(s) systems 132 via network 50. Using mortgage lender(s)/broker(s) systems 132, a broker and/or lender can register with platform 100.

For registered lenders and brokers, platform 100 can be configured to generate information and/or links within display screens or other outputs presented via App 200. The information and/or links can identify the lender or broker and, optionally, provide a link to one or more site, page, and/or system prompting a user (buyer) to provide inputs necessary for preapproval or prequalification for a mortgage loan. The preapproval or prequalification can set a borrowing threshold for the buyer, and may include certain conditions, e.g., a maximum loan to value ratio. If the preapproval or prequalification is successful, the mortgage lead module 130 can generate an electronic message to the mortgage broker or lender advising of the successful prequalification. Such an indication could also be provided to a real estate agent representing the buyer. In some embodiments, proof of preapproval or prequalification may cause the platform 100 or provide additional functionality to the user via App 200.

Mortgage lead module 130 can associate a lender or mortgage broker from a plurality of lenders or mortgage brokers with a client using one or more approaches, consistent with the terms of the real estate agent's or broker's registration. For example, the mortgage lead module 130 may incorporate an identification and/or link associated with a lender or mortgage broker in the outputs generated by App 200 as a form of a lead initiate by the real estate agent/broker.

In some embodiments, the selection of the lender or mortgage broker from a plurality of lenders or mortgage brokers can be based on a variety of criteria, such as location of user (e.g., buyer), location of property, listing price of property, estimated market value of property, forecasted market value of property, and/or forecasted market value of geographic region (e.g., state(s), city(ies), town(s), zip code(s), neighborhood(s), street(s) and so on. Additionally, or alternatively, such criteria could include a time of day, day of the week, a lead generation allotment, and/or other criteria.

A Buyer module 140 can be configured to receive, store, and process buyer information, e.g., target property search criteria. The buyer information can be input through a web browser interface and/or through App 200. In some embodiments, App 200, or a link to it, can be sent to the buyer via an electronic communication from a real estate agent/broker to the prospective buyer. Otherwise, a buyer could download App 200 from a different source, e.g., an online app store.

Once App 200 is loaded on a user device, e.g., a mobile device, platform 100 is configured to communicate with the buyer via App 200, to receive information and present information—such as through a set of display screens output via App 200 on a user's (e.g., buyer's) mobile phone or other device. Such user devices and/or systems are generally represented as buyers/sellers 162 in FIG. 1.

Buyer module 140 can solicit information from a buyer useful for searching for properties, referred to as target property information. Such target property information can include static quantitative categories of information, as in the prior art. However, additionally or alternatively, buyer module 240 can solicit other types and/or categories of target property information from a buyer, such as criteria related to or representing dynamic or projected values and/or qualitative indications of real estate properties. These dynamic values, e.g., property value, change over time—unlike static criteria, e.g., lot size, number of bedrooms, square feet.

In various embodiments, the buyer module can solicit, receive, store and/or process target property information that includes one or more of those listed in Table 1 below, which are not typical static quantitative categories of information. Rather these represent dynamic (D) and qualitative (Q) criteria or factors.

TABLE 1

| | |
|---|---|
| Value in 1 year/3 years (D) | Neighborhood's “vibe” (Q) |
| Monthly spend (based on budget) (D) | Distance from city (Q) |
| Potential for market bubble (D) | Cost of living |
| Priced below/above market (D) | Climate (Q) |
| Market stability (D) | Presence of Schools (Q) |
| Crime (Q) | Presence of Universities (Q) |

Some of these types of information are calculated as estimates based on projected future property values. In some embodiments, the future property values can be estimated relative to a specific street address, i.e., property-specific. In some embodiments, the future property values can be estimated for a street, neighborhood, zip code, town, or city, as examples. As examples, Value in 1 year/3 years, Potential for market bubble, and Market stability can each be determined based on projecting the value of the property to one or more points in time into the future. For example, Weiss Analytics LLC of Natick Mass. provides a technology platform that employs sophisticated algorithms processing large volumes of data to create accurate, house-specific indexes that can be used for projecting future property values for individual homes. Such indexes can be used to compare the future value or value trends of the specific home with other homes, within the local market, within larger markets (e.g., state or national), as well as assessing the house specific trends against other economic trends, which may include economic trends that are not directly real estate related, e.g., trends in employment, interest rates, GDP, one or more economic sectors, industries, and so on. Such systems can also be used to determine a present market value of a home, which could be different from a present listing price for the same home.

The Cost of living type of information may be determined from economic data sources for a region that includes a target property. The Monthly spend (based on budget) type of information may be determined based on mortgage and tax information related a target property, and, optionally, a cost of living for a region that includes the target property. The Neighborhood's “vibe” information may represent the make-up of the local population and be determined by percent of people in various age groups. For example, this type of information may be based on census data showing the make-up of a street or neighborhood based on typical census data, e.g., number of elementary school children, number of pets, and do on of others living on the street.

The Crime type of information may be determined by, for example, crime rates for the region (e.g., city, town, zip code, neighborhood, and/or street) that includes the target property. The Climate type of information may be determined by historical weather data for the region including the target property. The Distance from city type of information may be determined from known map and/or geographic information.

The Schools and Universities types of information may be obtained from city and town data sources. In some embodiments, the Schools type of information may also include rankings or performance data (e.g., based on standardized test scores of students) indicating the quality of education of schools in the area of the target property, e.g., public and/or private.

A Property search module 150 can be configured to search and filter properties utilizing the user's target property information. That is, the property search module 150 can be configured to access data sources and systems to obtain information and data that fulfills the user's target property information, and that can be used to calculate or otherwise determine information and data that fulfills the user's target property information from various data sources. When a property is determined to satisfy the buyer's criteria, an alert is generated and forwarded to App 200 on the user's device.

In some embodiments, property search module 150 can be configured to filter results based on the preapproval or prequalification threshold determined using mortgage lead module 130.

In various embodiments, in addition to accessing property listing systems for currently listed properties, such as MLS 172, an unlisted property module 160 may be included to access properties of the agent/broker not yet publically listed for sale. Such properties may be listed in the MLS system 172, even though not yet publicly listed. In some embodiments, the unlisted property module 160 may, alternatively or additionally, be configured to include properties in the target property search that are not privately or publically listed. The owners of such properties may have taken no steps toward selling, but their homes could still be presented in search results with an estimated current property value. The buyer may find such information useful and/or interesting for assessing a street or neighborhood including a target property, or for making an offer on a property not currently listed for sale. The unlisted property module 160 can be used, therefore, to augment or compliment the functionality of the property search module 150.

Tour module 170 can access other modules of platform 100 to provide a walking or driving tour of properties via App 200. App 200 can access the GPS functionality of a smart phone and/or of a vehicle, if the smartphone is coupled to the GPS system of the vehicle, to place and track the movement of the buyer along a street, as further discussed below. As the buyer moves into proximity of a property satisfying the buyer's criteria, the tour module 170 may send an alert to the buyer via App 200.

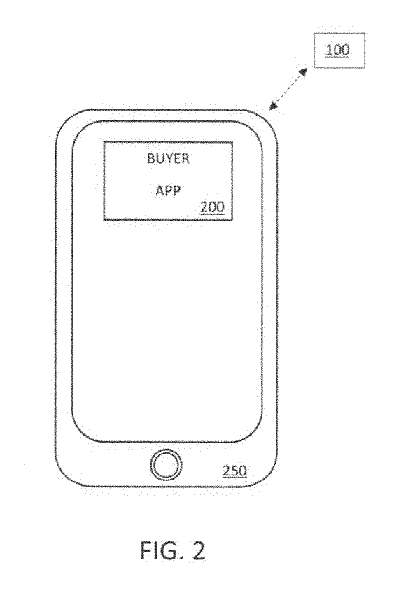

FIG. 2 is a diagram of an embodiment of a mobile phone 250 having a real estate alert and lead generation application (app) 200 loaded thereon, in accordance with aspects of the inventive concept. App 200 can be downloaded and installed on a mobile device, or other computer, and is configured to communicate with platform 100 and/or other systems and data sources useful and/or necessary to perform its functions. In some embodiments, one or more of the modules of platform 100 may form part of App 200, in whole or in part. That is, a module may have components that form part of App 200 and/or components that form part of platform 100 accessed by App 200 via network 50.

In various embodiments, App 200 accesses the national MLS and unique market analytics to uncover and notify users (e.g., buyers) of property listings that best fit the user's criteria (see, e.g., Table 1). The notification can take the form of an electronic alert sent to App 200 on the user's device indicating that a property compares favorably with respect to the buyer's criteria. Accordingly, one or more of the buyer's criteria can be used to establish corresponding thresholds, e.g., thresholds related to a property's current and/or future market value(s). App 200 is a data driven home purchasing application configured to help buyers find properties anywhere, e.g., anywhere in the USA, that are priced below market value and/or are expected to appreciate rapidly. As a result, homebuyers are no longer tethered to a specific metro region for finding a home. App 200 enables users to discover neighborhoods and properties that feel like home in an unfamiliar metro area.

In various embodiments, App 200, in conjunction with any necessary functionality of platform 100, is configured to enable a set of functions. One function is a property search function, which solicits a user's (e.g., a buyer's) property search criteria and generates a filtered list of properties in accordance with the user's criteria. Another function is a buyer tour function that enables App 200 to provide a guided property tour via a mobile device. Yet another function is an optional mortgage lead generation function, which can be provided through App 200 and the outputs thereof. And yet another function is an optional real estate agent/broker lead generate function, which can be provided through App 200 and the outputs thereof.

Property Search Function

App 200 includes a feature for buyers to help them find properties anywhere in the USA that are priced below market value and/or are expected to appreciate rapidly. Current and/or future market value can be determined by an automated property valuation system and set as a threshold value for search purposes. For example, if two homes are listed at $300,000, but the first has a market valuate (property valuation) of $320,000 and the second has a market value (property valuation) of $280,000, only the first property may be provided to the buyer in response to a search. The first property may be indicated as a “good deal” because of its value relative to the determined valuation. The second property could be completely omitted from the search results.

The properties can be filtered according to the various buyer's criteria, see, e.g., Table 1. App 200 enables users to discover neighborhoods and properties that feel like home in an unfamiliar metro area, based on their own criteria. In preferred embodiments, App 200 can access the national MLS and unique market analytics to uncover and notify users of property listings that best fit their criteria. When a property is determined to fit a user's criteria, an alert can be sent via App 200. If a new property comes on the market that fits a user's criteria, an alert can be sent via App 200. If a property on the market undergoes a price reduction to now fit a user's criteria, an alert can be sent via App 200.

In various embodiments, App 200 can be configured to allow users to indicate their interest in unlisted properties, generating a branded offer letter, or other communication, from an Agent to the owner of a property that is not yet on the market.

Buyer Tour Function

Using the tour module 170, App 200 enables a user to experience a tour of properties fitting his criteria, e.g., from anywhere. App 200 generates a curated list of properties that meet nuanced quality of life criteria and detailed financial criteria, as examples. Examples of such criteria are represented in Table 1.

In a stationary mode, App 200 provides the experience of a curated virtual tour from the comfort of one's own home. Using App 200, a user can flag properties for later viewing and sharing. This can be done by tactile screen or device interaction or by an audio command, in various embodiments.

In a mobile mode, a user operating a mobile device, e.g., a smartphone, can browse metro areas, neighborhoods, and so on for properties that meet the user's unique criteria. App 200 can be activated to provide alerts about nearby properties on the mobile device, e.g., as a buyer walks or drives by the property.

In this mode, a user can receive audio notifications or alerts about local houses and neighborhoods as he drives, which can be output from the mobile device directly or through a vehicle sound system to which the mobile device is connected. The app can include or link to navigation functionality to guide the buyer to the property.

Mortgage Lead Generation Function

The mortgage lead module 130 enables high quality lead generation for a mortgagee via a preapproval or prequalification process. Benefits for an enrolled mortgagee include:

a) Pre-purchase leads at a discount.

b) Access millennial, first time home buyer market.

c) Additional Branding potential with App 200

Agent/Broker Lead Generation Function

The R.E. agent/broker module 120 enables client lead generation for an enrolled agent and/or broker. Benefits for an enrolled agent and/or broker include:

a) Agent relationship is required to view property addresses.

b) Agents, register to receive leads or offer Drive to their clients.

c) Enables agents to lock in buyer broker fee.

d) Distribution opportunity through Inman Market

e) Intel with potential exposure to 500,000 agents per month.

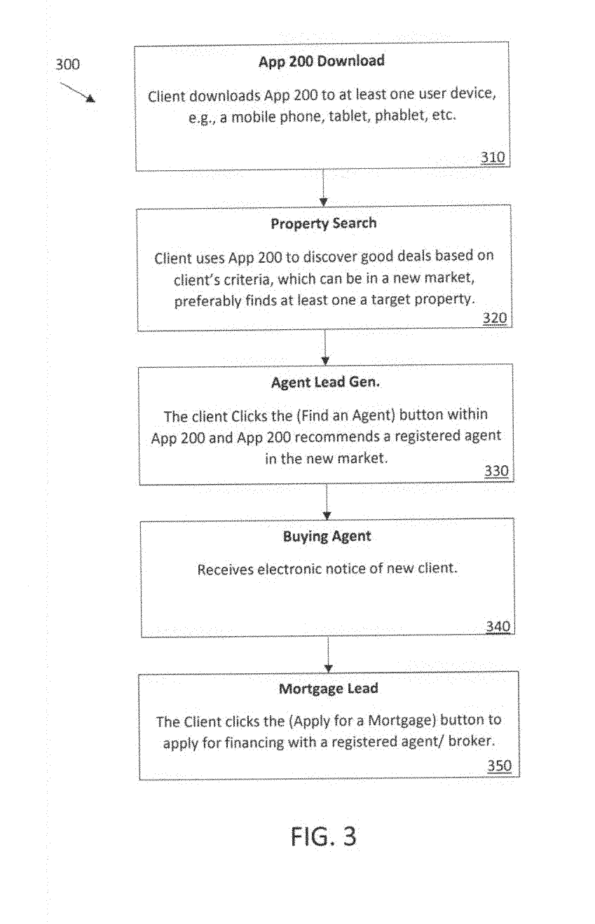

FIG. 3 is a flowchart of an embodiment of a real estate alert and lead generation method, in accordance with aspects of the inventive concept. The method 300 can be carried out by App 200 loaded on a mobile device and platform 100, to the extent needed to support App 200.

In step, 310, a client downloads and installs App 200. If the client is a buyer, the client can input his or her criteria for finding a property in a market. The market can be local to the buyer or remote. A market can be indicated by region, state, county, city, state, zip code, and/or street, as examples. Or the buyer can use App 200 to search in multiple markets, which are local and/or remote.

In step 320, the client initiates a search for at least one target property in at least one market. A target property is a property fitting the user's property search criteria. A search can return several properties fitting the user's criteria, i.e., several target properties. The properties need not all be in the same geographic area, if the user's criteria allowed for different markets.

In step 330, the client actuates a “Find an Agent” input device presented by App 200. This is an optional function that can be provided in various embodiments. The input device could be a “Find an Agent” button graphically displayed on a display screen presented within App 200. This causes a search for a real estate agent and/or broker in the area of the property search results. For example, if App 200 returned results for possible target properties in the Boston Metro area, the agent lead function would cause an identification and/or connection with an agent/broker in the same area to be sent via App 200. If different markets are shown, a different agent and/or broker can be indicated for different markets.

In step 340, the recommended agent/broker(s) receives an electronic communication from App 200 (or platform 100) advising of the new client connection.

In step 350, the client actuates an “Apply for a Mortgage” input device presented by App 200. This is an optional function that can be provided in various embodiments. The input device could be an “Apply for a Mortgage” button graphically displayed on a display screen presented within App 200. This causes a search for a mortgage broker and/or lender to be initiated. The mortgage broker and/or lender is preferably registered with platform 100, and may have an office in the area of the property search results.

The method may then continue to offer, acceptance, and closing.

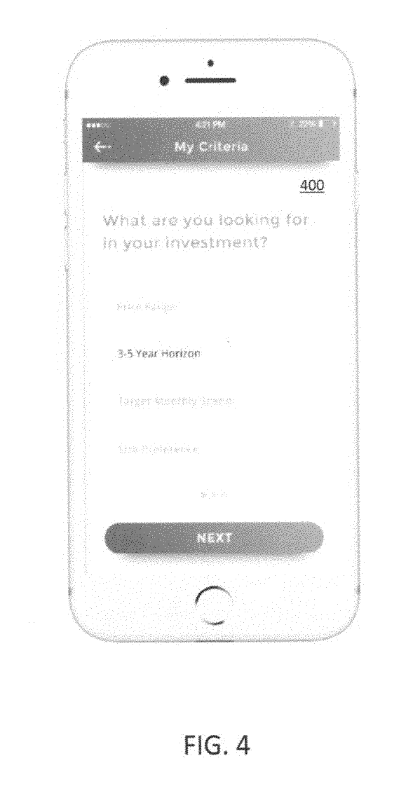

FIG. 4 is a diagram of an embodiment of a mobile phone having a real estate alert and lead generation application criteria input display 400, in accordance with aspects of the inventive concept. In the computer-generated display of FIG. 4, several representative fields are provided soliciting a user's, e.g., a buyer's, property search criteria. The criteria could be those from Table 1, in some embodiments. In this embodiment, the buyer has chosen to search for properties that are favorable with respect to the buyer's criteria in the 3-5 years. For example, the app 200 could determine if the property value is predicted to be favorable for the next 3-5 years. For example, a property that is predicted to appreciate over that timeframe may be considered favorable to the buyer.

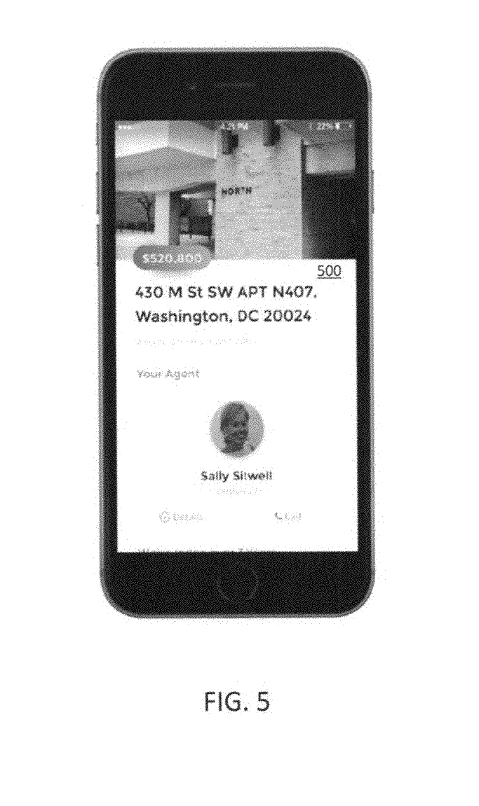

FIG. 5 is a diagram of an embodiment of a mobile phone having a real estate alert and lead generation application (app) display 500 providing a real estate agent lead, in accordance with aspects of the inventive concept. In FIG. 5, the display 500 identifies a real estate agent in association with a property, including a price and address. In this embodiment, the display provides contact information and/or mechanisms to initiate contact through the app 200.

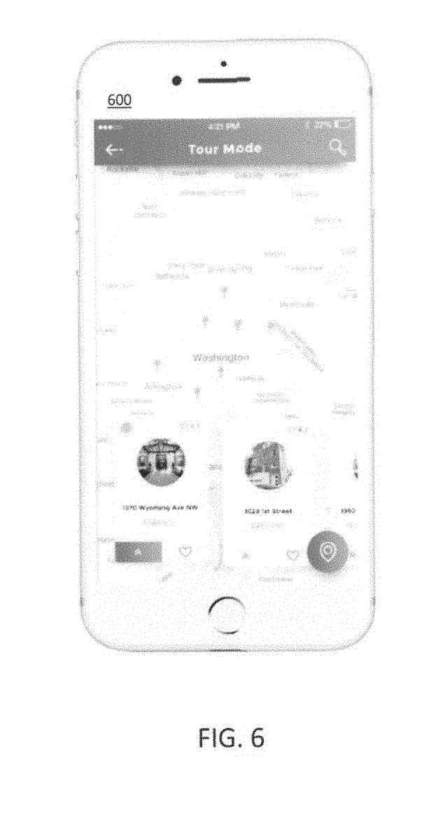

FIG. 6 is a diagram of an embodiment of a mobile phone having a real estate alert and lead generation application (app) display 600 for a touring mode, in accordance with aspects of the inventive concept. In this embodiment, the display 600 provides one ore more icons representing properties satisfying the buyer's criteria. An icon for a property shows an address with an image and a price for the property. The icons are overlaid on a map of the area including one or more of the properties represented in the icons. Pins are shown in the map to indicate locations of the properties on the map. A graphical mechanism in the shape of a heart is user selectable to indicate the buyer's selection of the property as a favorite.

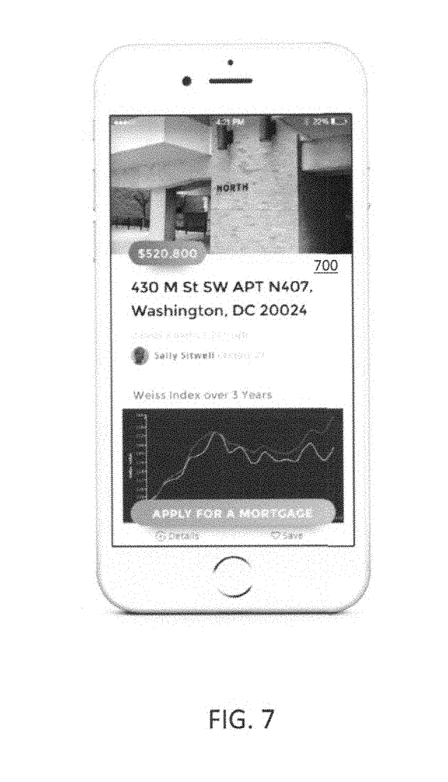

FIG. 7 is a diagram of an embodiment of a mobile phone having a real estate alert and lead generation application (app) display 700 providing a mortgage lead, in accordance with aspects of the inventive concept. In this embodiment, the display 700 is specific to a user-selected property. The display shows the address, price, a graphic of the property, and the real estate agent, property details. The display 700 also shows a graph depicting the calculated market value over time for the property, in conjunction with the other property information. The graph includes a display for 3 years, consistent with the user's indicated timeframe criteria in FIG. 4.

In this embodiment, there are two lines shown in the graph, where the Y-axis represents index values and the X-axis represents time. One line shows the index change over time for the zip code for the selected property and the other line shows an index change over time for the selected property, specifically. If the top line relates to the selected property, the property is predicted to outperform the market (by zip code) over the indicated period—indicating a good financial opportunity. But if the bottom line relates to the selected property, then the property may be considered to lag in performance—indicating a bad financial opportunity. The indexes can be formed by any of a variety of known methods, such as by basing predictions on historical sales data.

The display 700 also includes a user-selectable mortgage lead icon, labelled “APPLY FOR A MORTGAGE.” Selection of the icon initiates a process for the user/buyer to apply for a mortgage, as discussed above. In some embodiments, a lender or broker having a preexisting relationship with the real estate agent and/or platform 100 can receive a communication in response to user selection of the mortgage lead icon that establishes communication between the user/buyer and the mortgage lender or broker. Selection of the icon could also transition the user to a web site or display associated with the mortgage lender or broker to initiate data collection, e.g., the buyer completing an electronic loan application.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

For example, it will be appreciated that all of the features set out in any of the claims (whether independent or dependent) can combined in any given way.

What is claimed is:

1. A real estate alert generation system, comprising:
at least one processor and data storage device accessible via a computer network;
a set of functional modules comprising computer program code stored in the data storage device and executable by the at least one processor;
a computer application (app) loadable on a user device and configured to perform a set of functions in conjunction with the set of functional modules, wherein the app and set of functional modules are configured to collaboratively:
receive buyer search criteria, including criteria relating to at least one dynamic property value criteria and/or at least one qualitative criteria;
process the buyer search criteria to find one or more target real estate properties satisfying the buyer search criteria; and
generate alerts for output via the app identifying the one or more target real estate properties,
wherein dynamic property value criteria relate to property values that change over time and wherein the qualitative criteria relate to quality of life factors.

2. The system of claim 1, wherein the app is loaded on a mobile device.

3. The system of claim 1, wherein the app and set of functional modules are further configured to collaboratively:
generate a tour display including one or more of the target properties displayed in association with a map as user-selectable icons.

4. The system of claim 1, wherein the app and set of functional modules are further configured to collaboratively:
provide a mortgage lead icon that is a user-selectable link to a mortgage broker or lender via the app on the user device.

5. The system of claim 1, wherein the app and set of functional modules are further configured to collaboratively:
provide a graph having a first plot depicting projected property values of a selected property over a time period.

6. The system of claim 5, wherein the app and set of functional modules are further configured to collaboratively:
provide a second plot on the graph depicting projected property values of a selected area including the property over the time period.

7. The system of claim 1, wherein the at least one dynamic property value criteria and/or at least one qualitative criteria is at least one dynamic property value criteria and at least one qualitative criteria.

8. The system of claim 1, wherein the alerts include a text message to a mobile device having the app loaded thereon.

9. The system of claim 1, wherein the alerts include an email message to a mobile device having the app loaded thereon.

10. The system of claim 1, wherein the app and set of functional modules are further configured to collaboratively:
provide an alert via the app when a property has a price drop below a market value.

11. The system of claim 1, wherein the app and set of functional modules are further configured to collaboratively:
provide an alert via the app when a new property comes on the market that has a price below a market value.

12. The system of claim 1, wherein the app and set of functional modules are further configured to collaboratively:
provide a real estate agent or broker lead icon that is user-selectable to initiate electronic contact with a real estate agent or broker via the app on the user device.

13. The system of claim 1, wherein the app and set of functional modules are further configured to collaboratively:
identifying the one or more target real estate properties using a multi-listing service (MLS) registration of a real estate agent or broker to electronically search a MLS system.

14. The system of claim 1, wherein the app and set of functional modules are further configured to collaboratively:
generate alerts for output via the app identifying the one or more target real estate properties in different real estate markets.

15. The system of claim 14, wherein the app and set of functional modules are further configured to collaboratively:
provide a different real estate agent or broker lead icon for each real estate market that is user-selectable to initiate electronic contact with a real estate agent or broker via the app on the user device.
